(19) United States
(12) Patent Application Publication
(10) Pub. No.: US 2014/0328565 A1
(43) Pub. Date: Nov. 6, 2014

(54) MULTIMODE OPTICAL FIBER AND METHOD OF MANUFACTURING THE SAME

(71) Applicant: Sumitomo Electric Industries, Ltd., (US)

(72) Inventors: Itaru SAKABE, Yokohama-shi (JP); Keiko NISHIDA, Yokohama-shi (JP); Manabu SHIOZAKI, Yokohama-shi (JP)

(73) Assignee: SUMITOMO ELECTRIC INDUSTRIES, LTD., Osaka (JP)

(21) Appl. No.: 13/874,715

(22) Filed: May 1, 2013

(51) Int. Cl. G02B 6/028; C03B 37/027

(52) U.S. Cl. CPC G02B 6/0288; C03B 37/027
USPC 385/124; 65/435

(57) ABSTRACT

The present invention relates to a multimode optical fiber which can provide a smooth cut face suitable for fusion splicing between fibers. The multimode optical fiber has at least a core extending along a central axis and having an α-power refractive index profile, and a cladding, and a residual stress distribution in the core along a radial direction from the central axis has a shape with a maximum at a position intersecting with the central axis.

### BACKGROUND OF THE INVENTION

1. Field of the Invention

The present invention relates to a multimode optical fiber and a manufacturing method thereof.

2. Related Background Art

The multimode optical fibers are easy of splicing between fibers and connection to devices and therefore are commonly used in application of short-haul information transmission like a LAN (Local Area Network). Specifically, the multimode optical fibers are often used in a rather short length for optical fiber, e.g., in the cable length of not more than 500 m and are generally used with connectors attached to the two ends thereof.

Conventionally, the foregoing connector is obtained as follows: a coating is removed from the tip of an optical fiber cable to expose a glass part (a part of the multimode optical fiber), the glass part with an adhesive on a surface thereof is inserted into a ferrule member, a ferrule end face is polished, and then a housing member is attached to the tip part of the optical fiber cable (including the ferrule with the end face polished), completing the connector. There are also cases where an in-situ fusion splice type optical connector (Custom Fit Splice-On Connector: including a ferrule with an end face preliminarily polished in a state in which a connection optical fiber is fixed) is attached to the end of the multimode optical fiber in the optical fiber cable.

The foregoing custom fit splice-on connector is an optical connector to be assembled using a general-purpose fusion splicer. Namely, an optical fiber at a splicing site (which forms a part of an optical fiber cable) is permanently fusion-spliced to the connection optical fiber (with its end face flush with the ferrule end face) which has been polished in advance in a factory in a state in which it was bonded to be fixed to the optical connector ferrule, thus achieving low loss and low reflection.

FIGS. 1A and 1B are an assembly process drawing of a custom fit splice-on connector 10 which can be attached to an end of an optical fiber having any one of various structures, and a cross-sectional view thereof.

As shown in FIGS. 1A and 1B, a connection optical fiber 250 with an end face preliminarily polished so as to be flush with a ferrule end face is bonded to be fixed to an optical connector ferrule 240 with an end face preliminarily polished. A cable-side cap 230, a sleeve member 220, and a protection resin tube 210 are preliminarily attached to a tip part of an optical fiber cable 100 including a multimode optical fiber 110 (from which a resin coat has been removed to expose a glass portion corresponding to a part of the multimode optical fiber 110), and in this state, the connection optical fiber 250 bonded to be fixed to the optical connector ferrule 240 is fusion-spliced to the multimode optical fiber 110 (the exposed glass part of the optical fiber cable 100). The position indicated by arrow P in each of FIGS. 1A and 1B is a splice point.

After completion of the fusion splicing between the connection optical fiber 250 and the multimode optical fiber 110 at the splice point P, this splice point P is covered by the protection resin tube 210 and then the protection resin tube 210 is heated whereby the protection resin tube 210 comes into close contact with both of the connection optical fiber 250 and the multimode optical fiber 110. Thereafter, a ferrule-side cap 260 and the cable-side cap 230 are attached from both sides to the sleeve member 220, completing the custom fit splice-on connector 10,

### SUMMARY OF THE INVENTION

The Inventors conducted research on the conventional multimode optical fibers and found the problem as discussed below. In the present specification, a simple expression of “optical fiber” without any specific note shall mean “multimode optical fiber.”

There was the problem that in the attachment of the custom fit splice-on connector 10 to the multimode optical fiber 110, a yield of the fusion splicing between the connection optical fiber 250 and the multimode optical fiber 110 was significantly decreased, depending upon states of the cut face of the multimode optical fiber 110.

The present invention has been accomplished to solve the above problem and it is an object of the present invention to provide a multimode optical fiber allowing acquisition of a smooth cut face suitable for fusion splicing to another optical fiber, and a manufacturing method thereof.

The present invention relates to a GI (Graded Index) type multimode optical fiber having a GI type refractive index profile and the multimode optical fiber is clearly distinguished in structure from a single-mode optical fiber for long-haul transmission. The GI type multimode optical fiber includes a multimode optical fiber having a general structure composed of a high-refractive-index core region and a low-refractive-index cladding region, and also includes a multimode optical fiber with a low-refractive-index trench part provided on an outer peripheral surface of the core region (which will be referred to as BI type multimode optical fiber). The trench part has the refractive index lower than that of a peripheral region such as the cladding region and imparts resistance to variation of transmission performance due to bending, to the multimode optical fiber. The GI type multimode optical fiber also includes a low-refractive-index-cladding multimode optical fiber having a cladding with the refractive index set lower than that of pure silica glass by doping with a refractive-index decreasing agent such as fluorine. In the present specification, a simple expression of “multimode optical fiber” shall mean the GI type multimode optical fiber and also mean the 131 type multimode optical fiber and the low-refractive-index-cladding optical fiber belonging to the GI type multimode optical fiber.

A multimode optical fiber according to an embodiment of the present invention comprises at least: a core extending along a central axis and having an α-power refractive index profile in which a refractive index continuously decreases along a radial direction from the central axis; and a cladding provided on an outer peripheral surface of the core. The multimode optical fiber according to the present embodiment also includes a BI type multimode optical fiber comprising a trench part having a refractive index lower than that of the cladding, between the core and the cladding.

Particularly, in the multimode optical fiber according to the present embodiment, a residual stress distribution in the core is controlled to a special shape such as to obtain a smooth cut face suitable for fusion splicing between fibers. Namely, in a cross section perpendicular to the central axis, the residual stress distribution in the core along the radial direction from the central axis has a shape with a maximum at a position intersecting with the central axis.

In a preferred mode, a difference between a residual stress in the cladding and a maximum residual stress in the core is preferably not more than 0.2 GPa and a residual stress in a peripheral region of the core is preferably smaller than a residual stress in a central region of the core.

The whole or a part of the cladding may have a lower refractive index than that of pure silica glass. In this case, preferably, the cladding is in direct contact with the outer peripheral surface of the core and the cladding has the refractive index set substantially uniform along the radial direction from the central axis. This configuration enables implementation of the low-refractive-index-cladding optical fiber.

A maximum relative refractive index difference of the core with respect to the refractive index of pure silica glass is preferably not less than 0.9%. When the multimode optical fiber is the BI type multimode optical fiber with the trench part, a peripheral glass region is comprised of the trench part and the cladding.

In the case of the low-refractive-index-cladding optical fiber composed of the core and the cladding having the refractive index lower than that of pure silica glass, preferably, a maximum relative refractive index difference of the core with respect to the refractive index of pure silica glass is not less than 0.9% and a minimum relative refractive index difference of the cladding with respect to the refractive index of pure silica glass is lower than −0.30%.

A manufacturing method of the multimode optical fiber having the above-described structure (a method for manufacturing a multimode optical fiber according to an embodiment of the present invention) comprises: preparing an optical fiber preform for obtaining the GI type multimode optical fiber; and drawing one end of the optical fiber preform under a tension of not more than 40 g and under heat. The multimode optical fiber having the aforementioned structure is obtained through this fiber drawing step. The optical fiber preform prepared comprises: an inside glass region to become the core after the drawing; and an outside glass region to become the cladding after the drawing. In the case of the optical fiber preform for the BI type multimode optical fiber, an intermediate glass region to become the trench part after the drawing is provided between the inside glass region and the outside glass region.

In the optical fiber preform prepared, the inside glass region extends along the central axis and has an α-power refractive index profile in which a refractive index continuously decreases along the radial direction from the central axis. On the other hand, the outside glass region is provided outside the inside glass region.

Furthermore, in the manufacturing method according to an embodiment of the present invention, the one end of the optical fiber preform prepared may be drawn under the tension of not more than 30 g and under heat.

The outside glass region may have a portion with a refractive index lower than that of pure silica glass. In this case, preferably, the outside glass region is in direct contact with an outer peripheral surface of the inside glass region and the outside glass region has a refractive index set substantially uniform along the radial direction from the central axis.

In this case, preferably, a maximum relative refractive index difference of the inside glass region with respect to the refractive index of pure silica glass is not less than 0.9% and a minimum relative refractive index difference of a peripheral glass region surrounding the inside glass region and including the outside glass region, with respect to the refractive index of pure silica glass, is lower than −0.3%. In the case where the multimode optical fiber according to the present embodiment is the BI type multimode optical fiber having the trench part, the peripheral glass region in the optical fiber preform is composed of the intermediate glass region to become the trench part after the drawing, and the outside glass region to become the cladding after the drawing.

In the case of the optical fiber preform for obtaining a low-refractive-index-cladding multimode optical fiber which is composed of the core, and the cladding having the refractive index lower than that of pure silica glass, preferably, the maximum relative refractive index difference of the inside glass region with respect to the refractive index of pure silica glass is not less than 0.9% and a minimum relative refractive index difference of the outside glass region with respect to the refractive index of pure silica glass is lower than −03%.

By making use of the custom fit splice-on optical connector 10 having the above-described structure, for example, a splice condition between the connection optical fiber 250 and the multimode optical fiber 110 can be checked on a monitor of the fusion splicer. For this reason, we can enjoy the advantage of higher reliability of the splicing work. Since the optical fiber cable 100 to be spliced (the optical fiber installed at the assembly site of the connector) can be processed into an appropriate length, there is no need for storage of marginal cable length. The use of the custom fit splice-on optical connector 10 provides many advantages including implementation of downsizing by setting the fusion-spliced part between the connection optical fiber 250 and the multimode optical fiber 110 inside the housing of the connector, easier mounting on a device or the like, and so on.

Each of embodiments according to the present invention will become more fully understood from the detailed description given hereinbelow and the accompanying drawings. These examples are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, and that various modifications and improvements within the scope of the invention will become apparent to those skilled in the art from this detailed description.

### BRIEF DESCRIPTION OF THE DRAWINGS

FIGS. 1A and 133 are an assembly process drawing of a custom fit splice-on connector which can be attached to an end of an optical fiber having any one of various structures, and a cross-sectional view thereof.

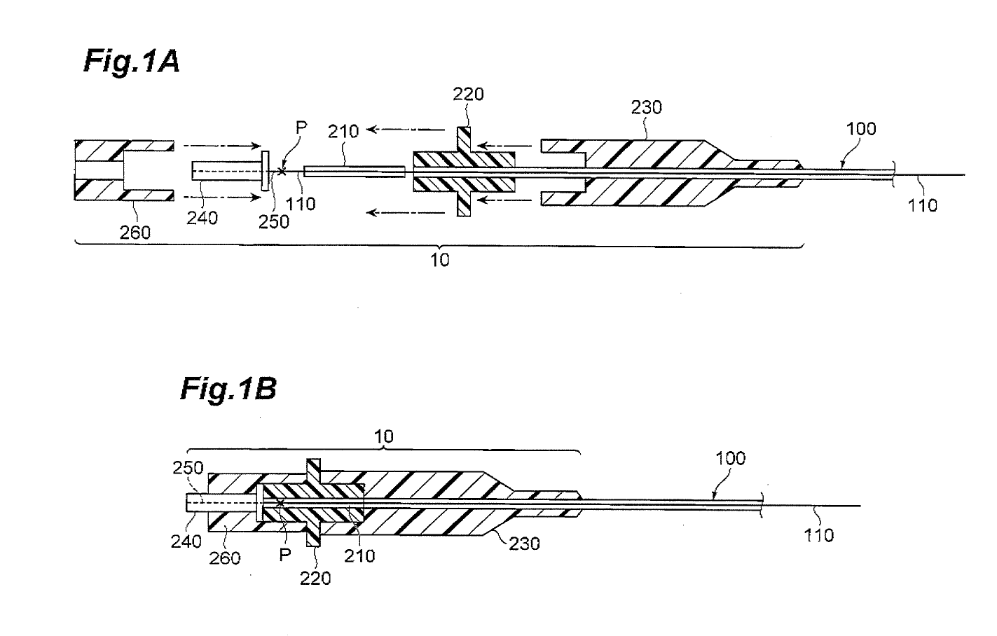

FIGS. 2A and 2B are a sectional view of a multimode optical fiber according to the first embodiment and a refractive index profile thereof,

FIGS. 3A and 313 are a sectional view of a multimode optical fiber according to the second embodiment and a refractive index profile thereof.

FIG. 4 is a drawing showing a schematic structure of a fiber drawing apparatus for obtaining the multimode optical fiber.

FIG. 5 is residual stress distributions for explaining determinant factors of residual stress in the multimode optical fiber,

FIG. 6 is residual stress distributions of respective samples of multimode optical fibers according to the first embodiment, which were drawn under various drawing tensions.

FIG. 7A is a drawing for explaining a method for fiber cut evaluation of each experimental sample of multimode optical fiber prepared, and FIG. 7B a table showing the result of the fiber cut evaluation, for each of samples of the multimode optical fibers according to the first embodiment and samples of multimode optical fibers according to a comparative example.

FIG. 8A is a photograph showing a cut face of one sample (in FIG. 7B) of the multimode optical fiber according to the comparative example, FIG. 8B a photograph showing a side face thereof, and FIG. 8C a drawing schematically showing a state of the cut face shown in FIG. 8A.

FIG. 9A is a photograph showing a cut face of one sample (in FIG. 7B) of the multimode optical fiber according to the first embodiment, and FIG. 9B a photograph showing a side face thereof.

FIG. 10A is a table showing the result of fusion splice evaluation, for each of samples of the multimode optical fibers according to the first embodiment and samples of multimode optical fibers according to the comparative example, and FIG. 10B a photograph showing a state after fusion splicing of one sample (in FIG. 10A) of the multimode optical fiber according to the comparative example.

FIG. 11 is residual stress distributions of several samples of the multimode optical fibers according to the first and second embodiments with different core diameters 2a, which were drawn under the tension of 100 g.

### DETAILED DESCRIPTION OF THE PREFERRED EMBODIMENTS

Multimode optical fibers and manufacturing methods thereof according to the present invention will be described below in detail with reference to the accompanying drawings. In the description of the drawings, the same elements will be denoted by the same reference signs, without redundant description.

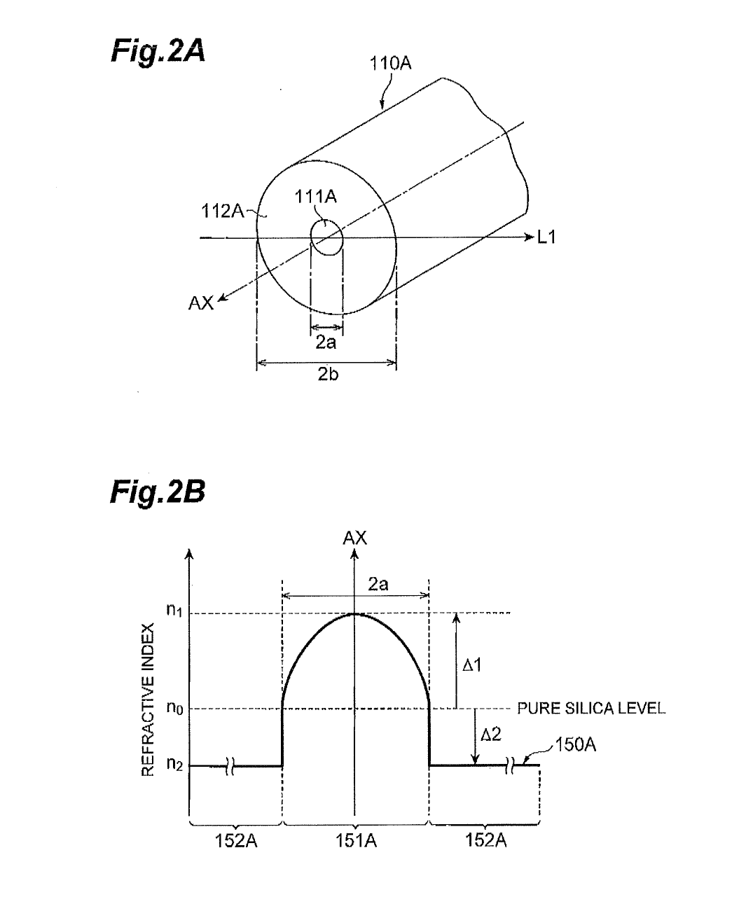

FIG. 2A is a sectional view of a multimode optical fiber 110A according to the first embodiment and FIG. 2B a refractive index profile 150A thereof. The multimode optical fiber 110A of this first embodiment is provided with a core 111A extending along a central axis (coincident with the optical axis AX), and a cladding 112A disposed in close contact with the outer periphery of the core 111A. The core 111A has an α-power refractive index profile in a diametrical direction (a direction perpendicular to the central axis of the optical fiber) and the cladding 112A has a constant refractive index equal to or smaller than a minimum refractive index of the core 111A.

The core 111A has an outside diameter 2a and a maximum refractive index n₁. Furthermore, the core 111A is doped with a refractive-index increasing agent such as GeO₂ in a predetermined concentration distribution, thereby having the α-power refractive index profile in which the refractive index continuously decreases along the radial direction from the optical axis AX as shown in FIG. 213. A maximum relative refractive index difference Δ1 of the core 111A with respect to the refractive index n₀ of pure silica glass is not less than 0.9%. On the other hand, the cladding 112A has an outside diameter 2b. Furthermore, the cladding 112A is substantially homogeneously doped with a refractive-index decreasing agent such as fluorine, thereby having the refractive index n₂ lower than the refractive index n₀ of pure silica glass. A relative refractive index difference Δ2 of the cladding 112A with respect to the refractive index n₀ of pure silica glass is lower than −0.3%. The above configuration realizes a low-refractive-index-cladding optical fiber. In the present specification, a relative refractive index difference of a glass region having a refractive index lower than the refractive index n₀ of pure silica glass is represented by a minus value. Therefore, that “the relative refractive index difference Δ2 of the cladding 112A is lower than −0.3%” as in the above example means that the refractive index n₂ of the cladding 112A is lower than the refractive index n₀ of pure silica glass and that an absolute value of the relative refractive index difference Δ2 is larger than 0.3%.

The refractive index profile 150A shown in FIG. 2B shows the refractive indices of the respective parts on a line L1 perpendicular to the optical axis AX (coincident with the diametrical direction of the multimode optical fiber 110A) in FIG. 2A; more specifically, a region 151A indicates the refractive index of each part of the core 111A along the line L1 and a region 152A the refractive index of each part of the cladding 112A along the line L1.

Particularly, the region 151A in the refractive index profile 150A in FIG. 2B has a shape with a maximum at the center of the core 111A coincident with the optical axis AX (the α-power refractive index profile). Therefore, the concentration of GeO₂ added for adjustment of refractive index also quickly decreases from the center of the core 111A toward the cladding 112A. As an example, the value of a for defining the shape of this refractive index profile is preferably approximately in the range of 1.9 to 2,2. The refractive index of the outermost part of the core 111A is equal to the refractive index n₀ of pure silica glass. This part is in contact with the innermost part of the cladding 112A, the refractive index of the innermost part of the cladding 112A is n₂, and thus the refractive index suddenly changes in an almost discontinuous manner between the outermost part of the core 111A and the innermost part of the cladding 112A.

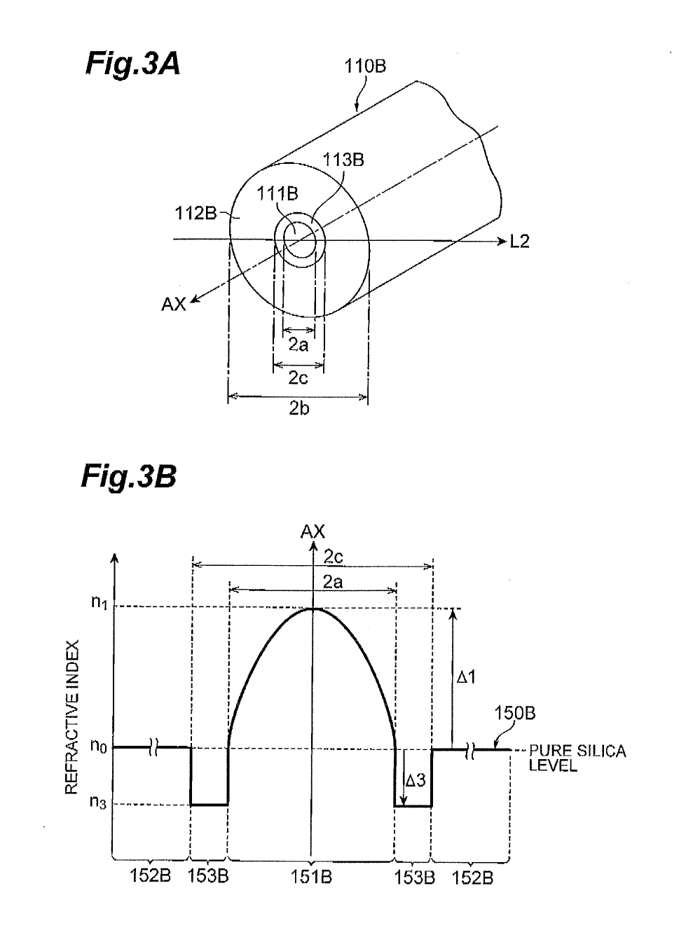

Furthermore, FIG. 3A is a sectional view of a multimode optical fiber 110E according to the second embodiment (BI type multimode optical fiber), and FIG. 3B a refractive index profile thereof. The multimode optical fiber 110B of this second embodiment is provided with a core 111B extending along a central axis (coincident with the optical axis AX), a trench part 113B provided on the outer periphery of the core 111B, and a cladding 112B provided on the outer periphery of the trench part 113B.

The core 11113 has the outside diameter 2a and the maximum refractive index n₁. Furthermore, the core 11113 is doped with a refractive-index increasing agent such as GeO₂ in a predetermined concentration distribution, thereby having the α-power refractive index profile in which the refractive index continuously decreases along the radial direction from the optical axis AX as shown in FIG. 3B. The maximum relative refractive index difference Δ1 of the core 111E with respect to the refractive index n₀ of pure silica glass is not less than 0.9%. The trench part 113B has an outside diameter 2c and is doped with a refractive-index decreasing agent such as fluorine, thereby having a refractive index n₃ lower than the refractive index n₀ of pure silica glass. On the other hand, the cladding 112B has the outside diameter 2b. Furthermore, in this second embodiment, the refractive index of the cladding 112B is equal to the refractive index n₀ of pure silica glass. A minimum relative refractive index difference Δ3 of a peripheral glass region surrounding the core 111B, with respect to the refractive index n₀ of pure silica glass (a relative refractive index difference of the trench part 113B in the second embodiment) is lower than −03%. The refractive index suddenly changes in an almost discontinuous manner at an interface between the core 111B and the trench part 113B and at an interface between the trench part 113B and the cladding 112B. The above configuration realizes a BI type multimode optical fiber.

The refractive index profile 150B shown in FIG. 3B shows the refractive indices of the respective parts on a line L2 perpendicular to the optical axis AX (coincident with the diametrical direction of the multimode optical fiber 110B) in FIG. 3A; more specifically, a region 151B indicates the refractive index of each part of the core 111B along the line L2, a region 152B the refractive index of each part of the cladding 112B along the line L2, and a region 153B the refractive index of each part of the trench part 113B along the line L2.

Particularly, the region 151B in the refractive index profile 150B in FIG. 313 has a shape with a maximum at the center of the core 111B coincident with the optical axis AX (the α-power refractive index profile). Therefore, the concentration of GeO₂ added for adjustment of refractive index also quickly decreases from the center of the core 111E toward the cladding 112B. As an example, the value of a for defining the shape of this refractive index profile is preferably approximately in the range of 1.9 to 2.2.

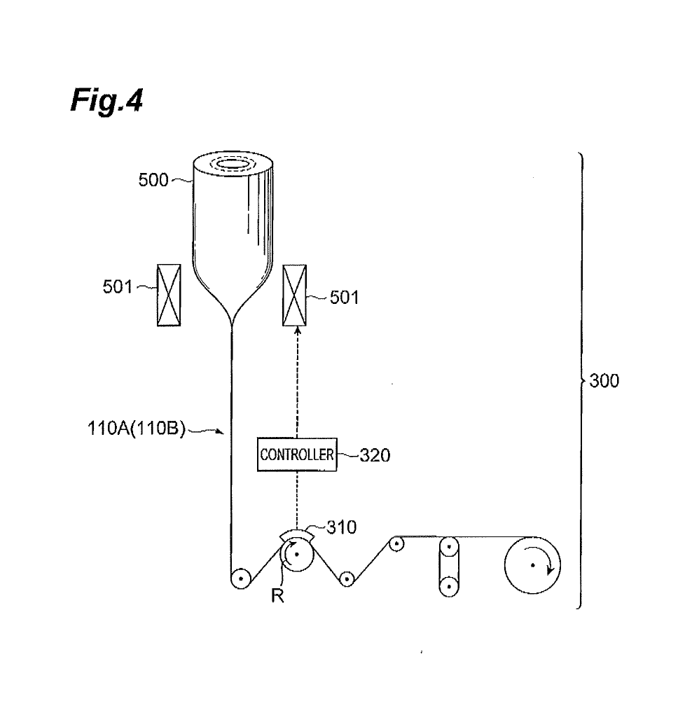

The multimode optical fibers 110A, 110B of the first and second embodiments having the above-described structures are obtained by a fiber drawing apparatus as shown in FIG. 4. FIG. 4 is a drawing showing a schematic structure of the fiber drawing apparatus for obtaining the multimode optical fibers.

The fiber drawing apparatus 300 shown in FIG. 4 is provided at least with a heater 501 to heat one end of an optical fiber preform 500 set therein, a capstan 310 to pull the heated one end of the optical fiber preform 500 under a predetermined tension, a controller 320, and a take-up drum to wind up an optical fiber. The capstan 310 rotates in a direction indicated by arrow R in FIG. 4, under control of the controller 320 and on that occasion, its rotational speed is regulated to adjust the outside diameters of the cladding and the core, and the outside diameter of the trench part if present. The controller 320 controls the heating temperature by the heater and the number of rotations of the capstan 310 to adjust the tension (drawing tension) applied to the heated one end of the optical fiber preform 500. For obtaining the multimode optical fiber 110A (low-refractive-index-cladding multimode optical fiber) having the structure shown in FIGS. 2A and 2B, the optical fiber preform 500 prepared has a double structure of an inside glass region to become the core after the drawing, and an outside glass region to become the cladding after the drawing. On the other hand, for obtaining the multimode optical fiber 110B (BI type multimode optical fiber) having the structure shown in FIGS. 3A and 3B, the optical fiber preform 500 prepared has a triple structure of an inside glass region to become the core after the drawing, an intermediate glass region to become the trench part after the drawing, and an outside glass region to become the cladding after the drawing.

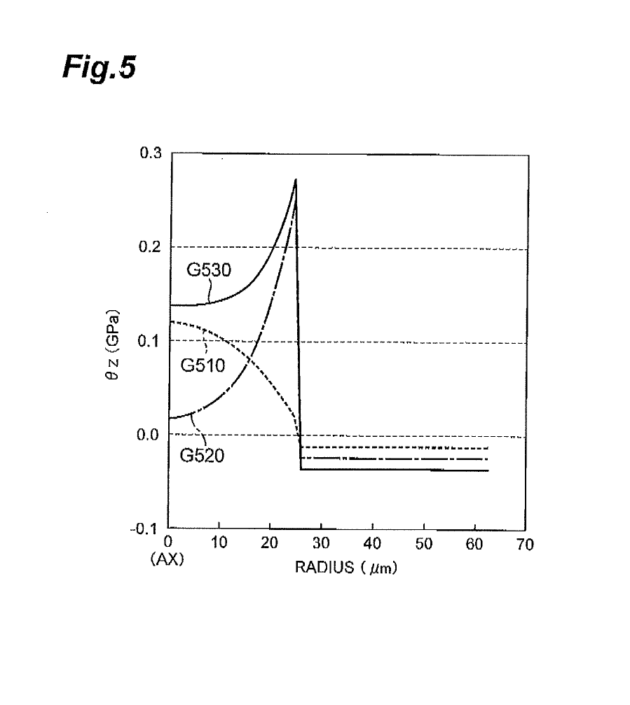

Next, residual stress of the multimode optical fiber obtained by the fiber drawing apparatus as described above will be described with reference to FIG. 5. FIG. 5 shows residual stress distributions for explaining determinant factors of residual stress in the multimode optical fiber. In this FIG. 5, the horizontal axis represents positions along the radial direction from the central axis of each sample of the multimode optical fiber, and the vertical axis residual stresses at respective positions.

The prepared sample is the multimode optical fiber with the sectional structure and refractive index profile shown in FIGS. 2A and 2B in which the core has the α-power refractive index profile and the cladding has the refractive index profile of the constant value, and is obtained by fiber drawing under the tension of 100 g by the fiber drawing apparatus 300 shown in FIG. 4. The outside diameter 2a of the core is 50 μm and the maximum relative refractive index difference Δ1 with respect to the refractive index of pure silica glass is 1.1%. The outside diameter 2b of the cladding is 125 μm and the relative refractive index difference Δ2 with respect to the refractive index of pure silica glass is −0.5%.

In FIG. 5, G530 indicates the residual stress distribution along the radial direction from the fiber center (optical axis AX), of the sample of the low-refractive-index-cladding multimode optical fiber shown in FIGS. 2A and 2B. Furthermore, G510 indicates a component attributed to thermal stress, of the residual stress distribution G530 (in the case of the drawing stress being 0 g) and G520 a component attributed to drawing tension, of the residual stress distribution G530 (in the case of the heating temperature being 0 K). As also seen from this FIG. 5, it is found that hi the sample of the low-refractive-index-cladding multimode optical fiber, the residual stress is high in a peripheral region near the periphery of the core part and the high residual stress in this peripheral region is mainly due to the drawing tension. It is confirmed by this result that the control on the drawing tension during the fiber drawing is effective to control on the residual stress in the resulting multimode optical fiber and, particularly, to control on the shape of residual stress distribution in the core.

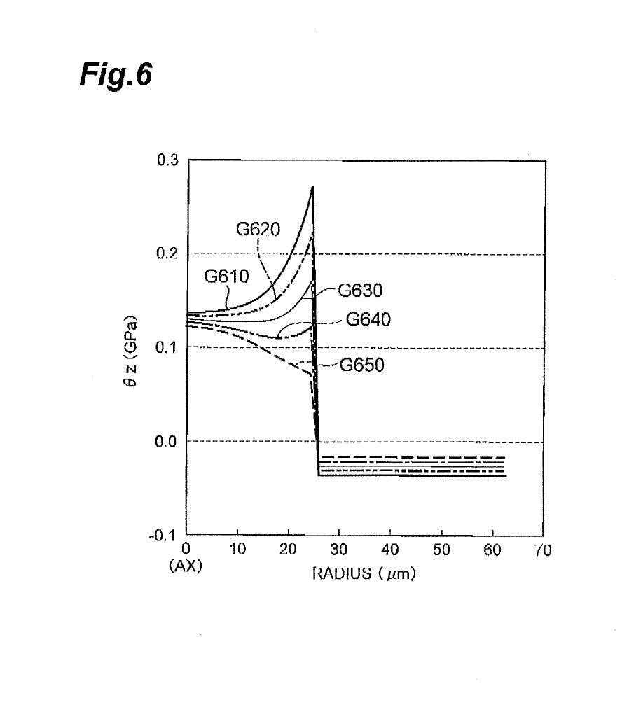

FIG. 6 is residual stress distributions of respective samples of multimode optical fibers according to the first embodiment, which were drawn under various drawing tensions. In this FIG. 6, the horizontal axis represents positions along the radial direction from the central axis of each sample of the multimode optical fiber, and the vertical axis residual stresses at respective positions. The samples all have the same structure. Namely, each sample is the multimode optical fiber shown in FIGS. 2A and 213 with the sectional structure and the refractive index profile shown in FIGS. 2A and 2B, in which the outside diameter 2a of the core is 50 μm and the maximum relative refractive index difference Δ1 with respect to the refractive index of pure silica glass is 0.1.1%. The outside diameter 2b of the cladding is 125 μm and the relative refractive index difference Δ2 with respect to the refractive index of pure silica glass is −0.5%.

In FIG. 6, G610 indicates the residual stress distribution of the sample having been drawn under the drawing tension of 100 g, G620 the residual stress distribution of the sample having been drawn under the drawing tension of 80 g, G630 the residual stress distribution of the sample having been drawn under the drawing tension of 60 g, 0640 the residual stress distribution of the sample having been drawn under the drawing tension of 40 g, and 0650 the residual stress distribution of the sample having been drawn under the drawing tension of 20 g. It is also seen from this FIG. 6 that at the drawing tension of 40 g, the residual stress at the core center becomes higher than that in the peripheral region of the core and the residual stress at the core center is a maximum. In other words, in the cross section perpendicular to the central axis of the optical fiber, the residual stress distribution along the radial direction from the central axis has a shape with a maximum at the position intersecting with the central axis. With the multimode optical fiber having the residual stress distribution of this shape, we can obtain a smooth cut face (i.e., a fiber end face to be fusion-spliced to another fiber becomes smooth).

The below will describe the results of fiber cut evaluation and fusion splice evaluation conducted while preparing ten samples of multimode optical fibers according to the embodiment of the present invention and ten samples of multimode optical fibers according to a comparative example.

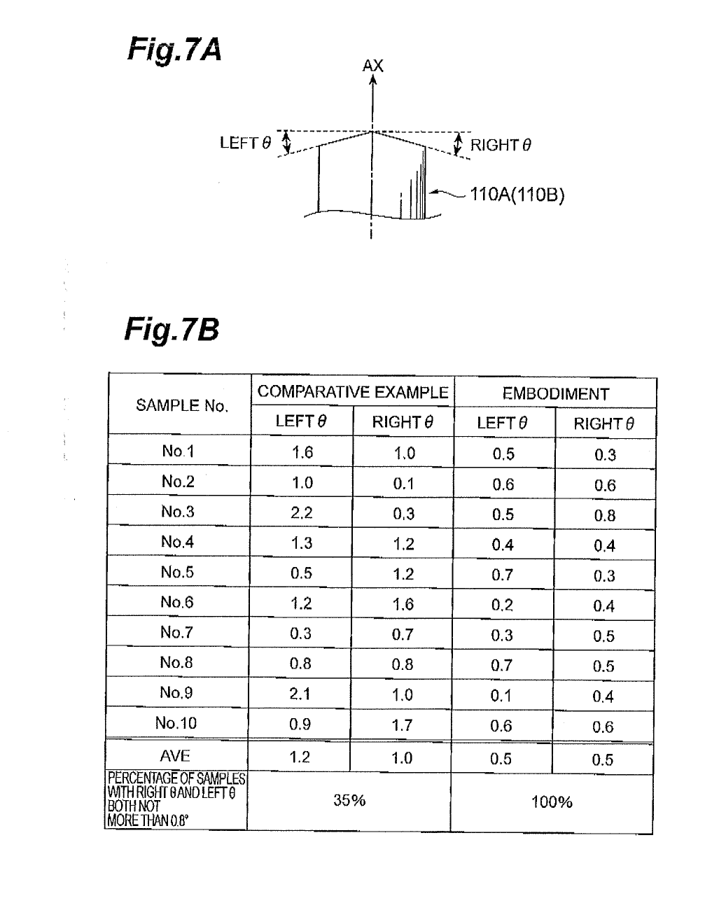

FIG. 7A is a drawing for explaining a method of the fiber cut evaluation of each experimental sample of the multimode optical fiber prepared, and angles of right and left end facets with respect to a plane perpendicular to the fiber center (optical axis AX) (which will be represented by right θ and left θ, respectively) were measured for each of the prepared samples to evaluate states of their cut faces. The samples of the comparative example prepared are the multimode optical fibers with the sectional structure and the refractive index profile shown in FIGS. 2A and 213 and were obtained by fiber drawing under the tension of 100 g by the fiber drawing apparatus 300 shown in FIG. 4. In each of the samples of the comparative example, the outside diameter 2a of the core is 50 μm and the maximum relative refractive index difference Δ1 with respect to the refractive index of pure silica glass is 1.1%. The outside diameter 2b of the cladding is 125 μm and the relative refractive index difference Δ2 with respect to the refractive index of pure silica glass is −0.5%. On the other hand, the samples of the present embodiment are also the multimode optical fibers with the sectional structure and the refractive index profile shown in FIGS. 2A and 2B but were obtained by fiber drawing under the tension of 30 g by the fiber drawing apparatus 300 shown in FIG. 4. In each of the samples of the present embodiment, the outside diameter 2a of the core is 50 μm and the maximum relative refractive index difference Δ1 with respect to the refractive index of pure silica glass is 1.1%. The outside diameter 2b of the cladding is 125 μm and the relative refractive index difference Δ2 with respect to the refractive index of pure silica glass is −0.5%.

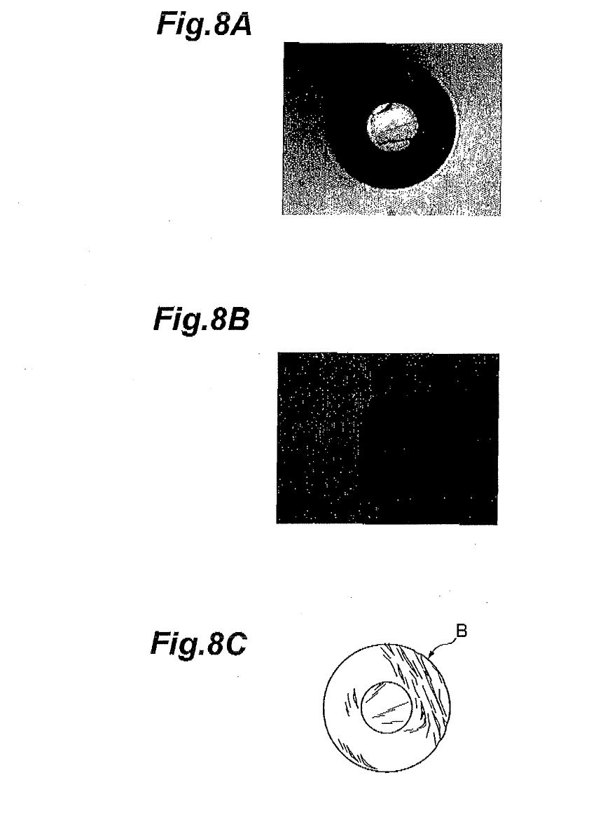

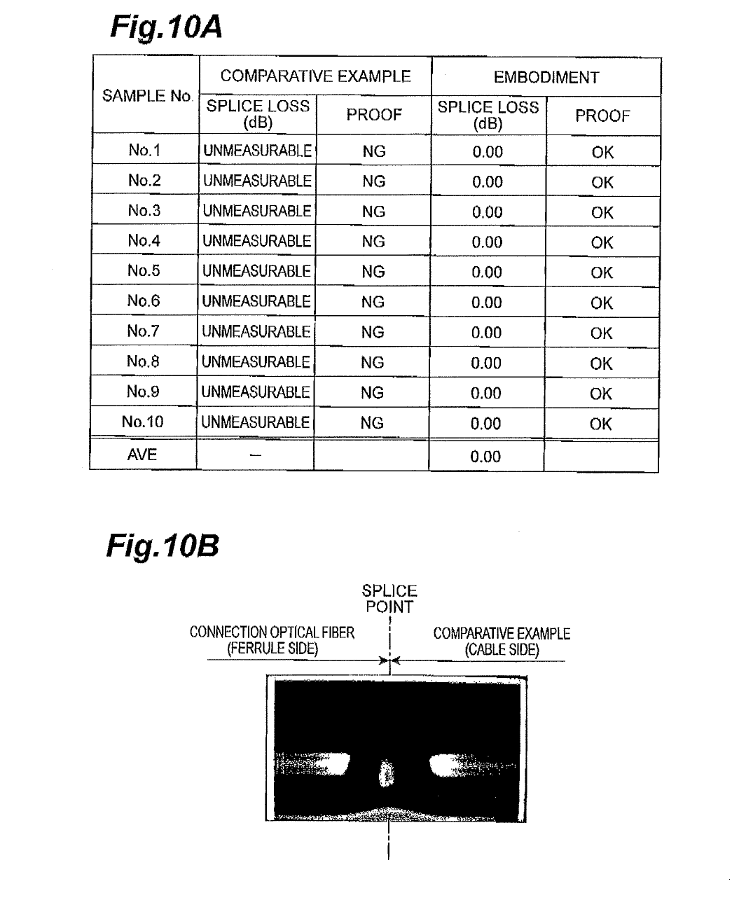

In the ten samples of the comparative example, as shown in FIG. 713, an average of left θ was 1.2° and an average of right θ was 1.0° in their cut faces. A smooth cut face suitable for fusion splicing is required to have left θ and right θ both not more than 0.8°, and only 35% of the ten prepared samples of the comparative example satisfied this requirement. A state of a typical cut face of the samples of the comparative example is shown in FIGS. 8A to 8C. FIG. 8A is a photograph showing a cut face (end face) of a sample of the comparative example, FIG. 8B a photograph showing a side face thereof, and FIG. 8C a drawing schematically showing the cut face shown in FIG. 8A. As also seen from these FIGS. 8A to 8C, a large number of flaws (uneven shape) are made in the cut face (end face) of the sample of the comparative example. In the evaluation of actual fusion splicing to a connection optical fiber, as shown in FIG. 10A, the splice loss was unmeasurable in all the samples. Namely, as shown in FIG. 10B, it was difficult to fusion-splice each of the samples of the comparative example to the connection optical fiber. Furthermore, all the samples also resulted in rupture in proof tests of the samples of the comparative example (tensile strength tests to pull each sample by about 1% along the lengthwise direction).

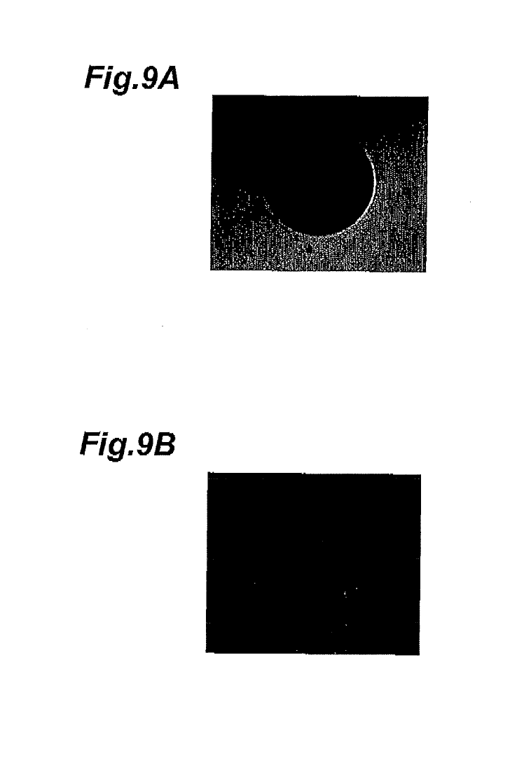

On the other hand, in the ten samples of, the present embodiment, an average of left θ was 0.5° and an average of right θ was also 0.5° in their cut faces. All the samples satisfied the end face angle required of the smooth cut face suitable for fusion splicing (left θ and right θ both not more than 0.8°). A state of a typical cut face of the samples of the present embodiment is shown in FIGS. 9A and 9B. FIG. 9A is a photograph showing a cut face (end face) of a sample of the present embodiment, and FIG. 9B a photograph showing a side face thereof. As also seen from these FIGS. 9A and 9B, the cut face (end face) of the sample of the present embodiment is smooth. In the evaluation of actual fusion splicing to a connection optical fiber, as shown in FIG. 10A, the splice loss was 0 dB in all the samples. Furthermore, all the samples were also confirmed to have sufficient strength in proof tests of the samples of the present embodiment.

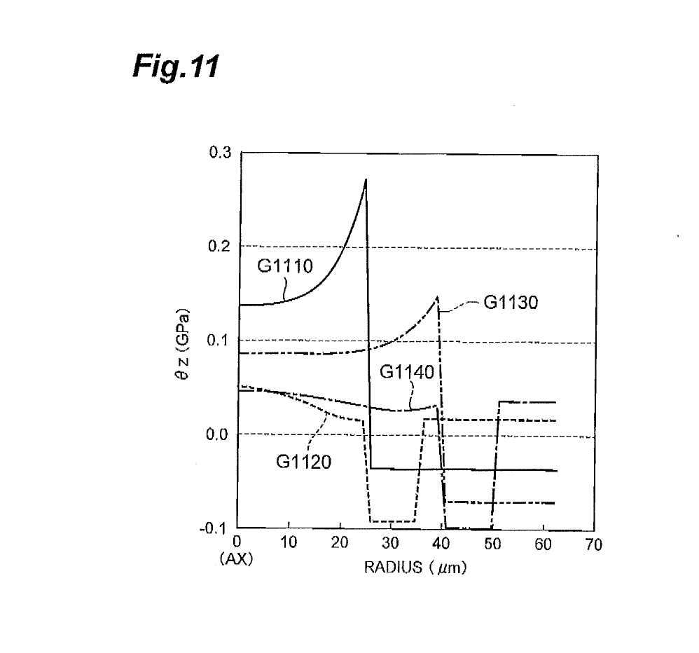

FIG. 11 is residual stress distributions of several samples of the multimode optical fibers according to the first and second embodiments with different core diameters 2a, which were drawn under a large tension (100 g). In this FIG. 11, the horizontal axis represents positions along the radial direction from the central axis of each sample of the multimode optical fiber, and the vertical axis residual stresses at respective positions. In FIGS. 11, G1110 and G1130 are the residual stress distributions in respective samples of multimode optical fibers 110A having the structure shown in FIGS. 2A and 2B. G1110 indicates the residual stress distribution of the sample with the core diameter 2a of 50 μm, which was drawn under the tension of 100 g, and G1130 the residual stress distribution of the sample with the core diameter 2a of 80 μm, which was drawn under the tension of 100 g. Furthermore, G1120 and G1140 are the residual stress distributions in respective samples of multimode optical fibers 110B (BI type multimode optical fibers) having the structure shown in FIGS. 3A and 3B. Each of the samples of the BI type multimode optical fibers is provided with the trench part 113B having the relative refractive index difference of −0.3% with respect to the refractive index of pure silica glass and the width of 10 μm (c-a shown in FIG. 3B). G1120 indicates the residual stress distribution of the sample with the core diameter 2a of 50 μm, which was drawn under the tension of 100 g, and G1140 the residual stress distribution of the sample with the core diameter 2a of 80 μm, which was drawn under the tension of 100 g.

As seen from FIG. 11, it is difficult to obtain a smooth cut face suitable for fusion splicing between fibers, in the case of each sample of the multimode optical fiber with the core having the α-power refractive index profile and the cladding having the refractive index profile of the constant value, which was drawn under the tension of 100 g, because a peak (maximum) of residual stress is present near the interface between the core 111A and the cladding 112A. In the case of each sample of the BI type multimode optical fiber having been drawn under the tension of 100 g, the residual stress is larger on the central side than on the peripheral side of the core 111B. For this reason, it is found that by disposing the appropriate trench part between the core and the cladding, the shape of the residual stress distribution can be controlled to some extent in the case of the BI type multimode optical fiber even if it is one drawn under the tension of not less than 40 g.

Since the smooth cut face is obtained by appropriate control of the drawing tension in the case of the multimode optical fiber of the present embodiment as described above, it becomes feasible to improve the yield of fusion splicing between fibers after adjustment of length.

From the above description of the present invention, it will be obvious that the invention may be varied in many ways. Such variations are not to be regarded as a departure from the spirit and scope of the invention, and all improvements as would be obvious to those skilled in the art are intended for inclusion within the scope of the following claims.

1. A multimode optical fiber comprising:
a core having an α-power refractive index profile; and
a cladding provided outside the core,
wherein a residual stress distribution along a radial direction from a central axis of the multimode optical fiber has a maximum value within the core, and
wherein the residual stress distribution has a shape so that a residual stress discontinuously decreases at an interface between the core and an outside layer being in direct contact with the core, and that the residual stress is minimized outside the core.

2. The multimode optical fiber according to claim 1, wherein the cladding has a portion with a refractive index lower than the refractive index of pure silica glass.

3. The multimode optical fiber according to claim 2, wherein the cladding is in direct contact with an outer peripheral surface of the core and the cladding has the refractive index set substantially uniform along the radial direction from the central axis.

4. The multimode optical fiber according to claim 1, wherein when a relative refractive index difference is defined as a value obtained by dividing a refractive index difference from the refractive index of pure silica glass by the refractive index of pure silica glass, a maximum relative refractive index difference of the core is not less than 0.9% and a minimum relative refractive index difference of a peripheral glass region surrounding the core and including the cladding is lower than −0.3%.

5. The multimode optical fiber according to claim 3, wherein when a relative refractive index difference is defined as a value obtained by dividing a refractive index difference from the refractive index of pure silica glass by the refractive index of pure silica glass, a maximum relative refractive index difference of the core is not less than 0.9% and a minimum relative refractive index difference of the cladding is lower than −0.30%.

6. A manufacturing method for manufacturing a multimode optical fiber, the manufacturing method comprising:
preparing an optical fiber preform comprising: an inside glass region to become a core after drawing, said inside glass region having an α-power refractive index profile; and an outside glass region to become a cladding after the drawing, said outside glass region being provided outside the inside glass region; and
drawing one end of the optical fiber preform prepared, under a tension of not more than 40 g and under heat.

7. The manufacturing method according to claim 6, wherein the one end of the optical fiber preform prepared is drawn under the tension of not more than 30 g and under heat.

8. The manufacturing method according to claim 6, wherein the outside glass region has a portion with a refractive index lower than the refractive index of pure silica glass.

9. The manufacturing method according to claim 8, comprising: drawing the optical fiber preform in which the outside glass region is in direct contact with an outer peripheral surface of the inside glass region and in which the refractive index in the outside glass region is set substantially uniform along a radial direction from a central axis of the optical fiber preform.

10. The manufacturing method according to claim 6, wherein when a relative refractive index difference is defined as a value obtained by dividing a refractive index difference from the refractive index of pure silica glass by the refractive index of pure silica glass, a maximum relative refractive index difference of the inside glass region is not less than 0.9% and a minimum relative refractive index difference of a peripheral glass region surrounding the inside glass region and including the outside glass region is lower than −0.3%.

11. The manufacturing method according to claim 9, wherein when a relative refractive index difference is defined as a value obtained by dividing a refractive index difference from the refractive index of pure silica glass by the refractive index of pure silica glass, a maximum relative refractive index difference of the inside glass region is not less than 0.9% and a minimum relative refractive index difference of the outside glass region is lower than −0.3%.

12. The multimode optical fiber according to claim 1, wherein the residual stress distribution has the shape so that the residual stress gradually increases in a peripheral region within the core.
